(19) United States
(12) Patent Application Publication
(10) Pub. No.: US 2021/0228435 A1
(43) Pub. Date: Jul. 29, 2021

(54) HANDHELD MASSAGE DEVICE AND METHOD OF USE

(71) Applicant: Daniel Edward Carr, Los Angeles, CA (US)

(72) Inventor: Daniel Edward Carr, Los Angeles, CA (US)

(21) Appl. No.: 17/167,461

(22) Filed: Feb. 4, 2021

Related U.S. Application Data
(63) Continuation of application No. 17/065,450, filed on Oct. 7, 2020, now abandoned.
Application No. 17/065,450 is a continuation-in-part of application No. 16/657,958, filed on Oct. 18, 2019.

(51) Int. Cl. A61H 7/00

(52) U.S. Cl. CPC A61H 7/003; A61H 2201/1695; A61H 2201/1645; A61H 2201/0153

(57) ABSTRACT

A massage tool that provides ergonomic support to the user's hands and thumbs is disclosed. The tool may include a hand grip with a forward extending thumb portion. A series of massage ridges may be positioned beneath the thumb portion such that downward pressure applied to the thumb portion (e.g., by the user's thumb) may be transferred to the ridges to facilitate the massage. Two massage tools may be combined to form a combined massage tool assembly that may be used with two hands.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### RELATIONSHIPS TO PRIOR APPLICATIONS

This application is a Continuation of U.S. patent application Ser. No. 17/065,450, filed Oct. 7, 2020, which is a Continuation-in-Part to U.S. patent application Ser. No. 16/657,958, filed Oct. 18, 2019, the entire contents of which are hereby fully incorporated herein by reference for all purposes.

### FIELD OF THE INVENTION

This invention relates to massage tools, including a manual massage tool with bottom ridges.

### BACKGROUND

Muscular scar tissue adhesions are a direct cause of structural chronic pain. However, the scar tissue is very difficult to break down using one's bands or other body parts (e.g., during a body massage). For example, pointed and/or rolling downward pressure perpendicular to the grain of the muscle (“cross-fiber”) must be applied to the scar tissue to successfully break it down. However, the current technique of applying this pressure using one's thumb(s) is difficult to sustain and may cause damage to the hands of the massage therapist, possibly prematurely ending the therapist's career.

Thumb massage tools currently on the market include flat surfaces not adequate to provide the targeted cross-fiber pressure necessary to break down the scar tissue and to lengthen the associated peripheral nerves. In addition, the flat tools are not able to grip the individual muscles (or groups of muscles) as necessary for the breakdown of the scar tissue adhesions. Also, these flat tools are designed for a single hand application with no possibility of increasing pressure by using both hands in unison for enhanced cross-fiber friction and nerve lengthening.

Accordingly, there is a need for a massage tool that provides ergonomic support to the massage therapist's hands and thumb during use, and that includes ridges that may be used to grip the recipient's muscles as necessary for the elimination of scar tissue adhesions through cross-fiber friction and for the lengthening of associated peripheral nerves. There is also a need for a tool that may be combined with a second tool to provide accurate two-handed pressure for these techniques.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows aspects of a massage device according to exemplary embodiments hereof;

FIG. 2 shows aspects of arm, hand and thumb alignment according to exemplary embodiments hereof;

FIGS. 3, 3A and 3B show aspects of a massage device according to exemplary embodiments hereof;

FIGS. 3C and 3D show aspects of a massage device ridge according to exemplary embodiments hereof;

FIG. 4 shows aspects of a massage device according to exemplary embodiments hereof;

FIG. 5 shows aspects of a massage device thumb portion according to exemplary embodiments hereof;

FIGS. 6A, 6B, 7 and 7A-7F show aspects of a massage device ridges according to exemplary embodiments hereof;

FIG. 8 shows aspects of a massage device attachment system according to exemplary embodiments hereof;

FIG. 9 shows aspects of a combined assembly according to exemplary embodiments hereof;

FIG. 10 shows aspects of a massage device attachment system according to exemplary embodiments hereof;

FIG. 11 shows aspects of a combined assembly according to exemplary embodiments hereof;

FIG. 12 shows aspects of aligned arms and thumbs according to exemplary embodiments hereof;

FIGS. 13-14 show aspects of a massage device attachment system according to exemplary embodiments hereof;

FIGS. 14A-14E show aspects of a multi-device massage assembly according to exemplary embodiments hereof; and

FIGS. 15-16 show aspects of a massage device ridges according to exemplary embodiments hereof.

### DETAILED DESCRIPTION OF EXEMPLARY EMBODIMENTS

In general, the device and method according to exemplary embodiments hereof includes a massage tool for the manipulation of bodily tissues and nerves for therapeutic and/or relaxation purposes, and the tool's method of use thereof.

In some embodiments, the device includes a massage tool with an ergonomic handle. The handle includes a hand grip portion configured with a forward extending thumb portion. The hand grip portion may be held within the palm and fingers of the user's hand while the user's thumb extends forward into the thumb portion. In general, the device may be held within one hand.

The tool may also include underside ridges adapted to contact the bodily tissues and nerves to be massaged. During use, downward and crossward pressure may be applied to the ridges by the user's thumb and hand. In this way, the device may be used to facilitate the massage.

In some embodiments, two devices may be attached together to form a two-hand massage tool assembly.

Further details of the device, as well as the device's methods of use will be described in detail below.

The following detailed description is not intended to limit the current invention. Alternate embodiments and variations of the subject matter described herein will be apparent to those skilled in the art.

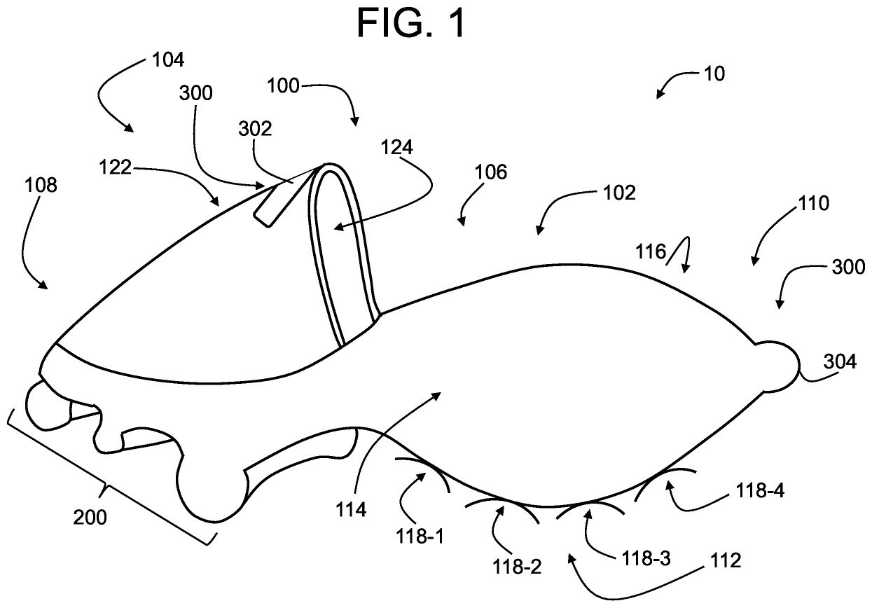

Referring now to FIGS. 1-13, the device 10 according to exemplary embodiments hereof will be described in further detail. Where the same or similar components appear in more than one figure, they are identified by the same or similar reference numerals.

In one exemplary embodiment as shown in FIG. 1, the device 10 may include a handle portion 100, an underside ridge portion 200 and an attachment system 300. The attachment system 300 may facilitate the attachment of two or more devices 10 together to form a multi-device assembly 400. The device 10 may include other elements and/or components that may be necessary for the device 10 to perform its desired functionalities as described in this specification.

Handle Portion

In some exemplary embodiments hereof as shown in FIG. 1, the device 10 includes a handle portion 100 comprising a hand grip portion 102 and a thumb portion 104. In general, the thumb portion 104 is positioned forward of the hand grip portion 102.

In some embodiments, the device 10 may be adapted to be held within the right hand, the left hand, and/or using either hands. As will be described below, in some embodiments, design elements of the device are specific to a right-handed device or a left-handed device. In other embodiments, the design elements may allow use of the device by either the right hand or the left hand.

For the purposes of this specification, the device 10 will be described with reference to a right-handed device (to be used with the right hand). However, it is understood by a person of ordinary skill in the art that the details described may also pertain to a left-handed device (possibly mirrored as necessary) and/or a device that may be used with either hand. It is also understood that the scope of the device is not limited in any way by the hand with which it is used.

The handle portion 100 may generally include a top 106, a front 108, a back 110, a bottom 112, a left side 114 and a right side 116. The hand grip portion 102 may be formed to ergonomically fit the anatomical features and contours of a human hand when the hand is placed on the grip 102. The hand grip 102 may preferably be formed of silicon or other types of natural and/or synthetic rubber and may also be formed of other materials such as metals, plastics, leather, synthetic leather, wood, or other types of materials. Accordingly, the hand grip 102 may be molded, sculpted, sewn or otherwise manufactured. The hand grip 102 also may be formed of a combination of types of materials. For example, the core of hand grip 102 may be formed of a plastic or a hard rubber while the outer surface of the hand grip 102 may be formed of a soft silicon layer. Other types and combinations of materials may also be used.

When grasping the hand grip 102, the palm of the user's right hand may generally contact the top 104 and right side 116 of the grip 102, with his/her fingers generally extending from the right side 116 across the bottom 112 to the left side 114. In this position, the thumb of the user's hand may extend forward towards the front 104 of the grip portion 102 and into the thumb portion 104.

On the underside 112, the hand grip 102 may include one or more finger recesses 116 that may resemble channels or indentations. It may be preferable that the hand grip 102 include up to four finger recesses 118-1, 118-2, 118-3 and 118-4 (collectively and individually 118), one for each finger of the human hand. Referring to the right-handed tool 10 of FIG. 1, finger recess 118-1, being on the far left, may be formed to receive and accommodate the user's index finger, finger recess 118-2 may be formed to receive and accommodate the user's middle finger, finger recess 118-3 may be formed to receive and accommodate the user's ring finger, and finger recess 118-4 may be formed to receive and accommodate the user's small finger.

However, other numbers of finger recesses 118 may also be used (e.g., one finger recess 118-1 for the user's index finger only) and the number of finger recesses in no way limits the scope of the device 10. It is also understood the hand grip 102 may not include finger recesses 118 and that the hand grip 102 may instead be smooth, include a texture or other type of patterned surface and any combination thereof.

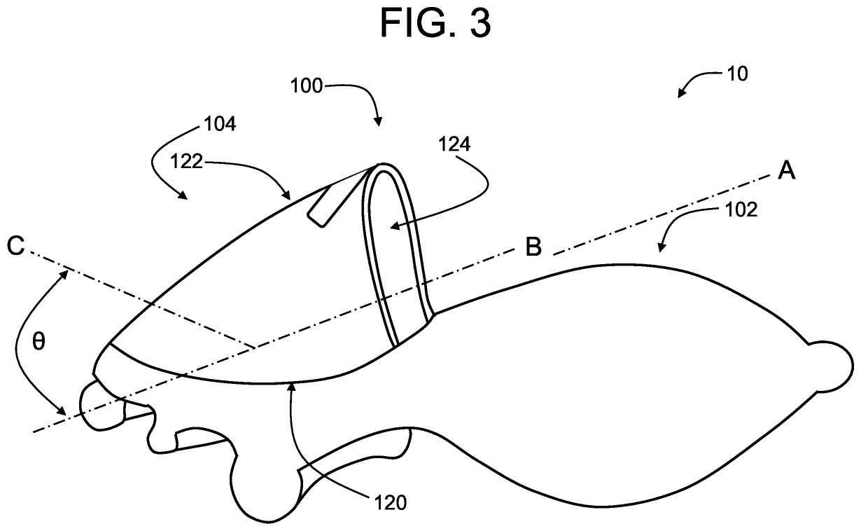

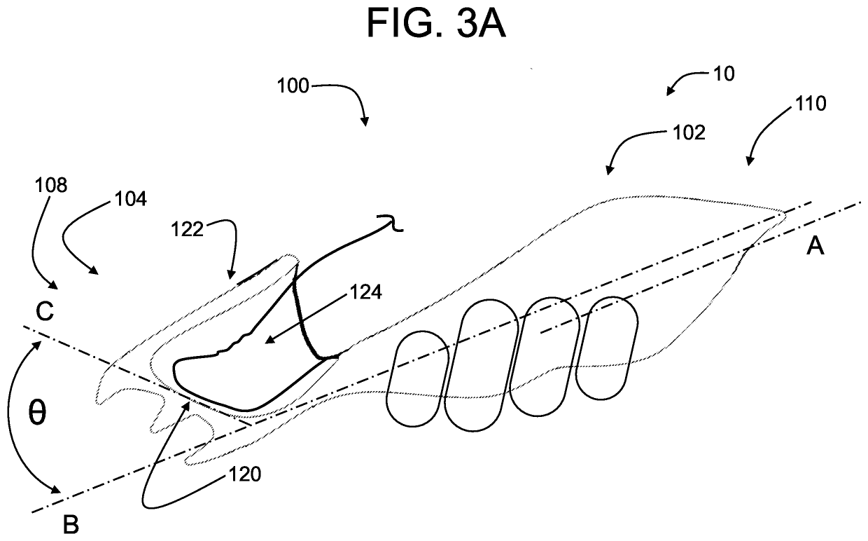

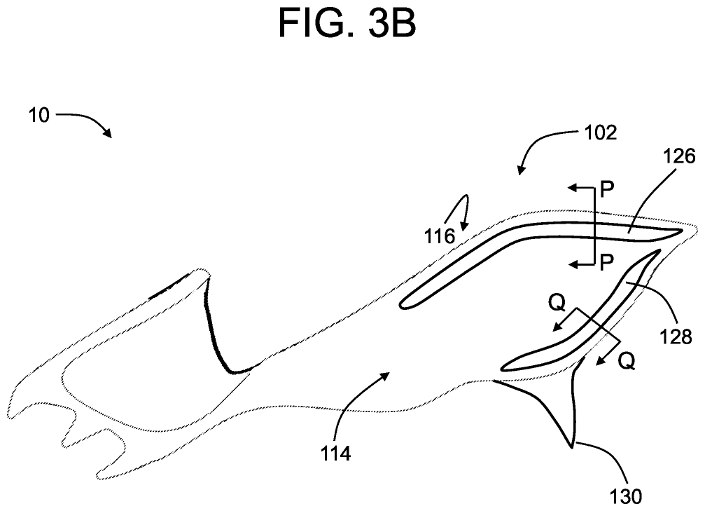

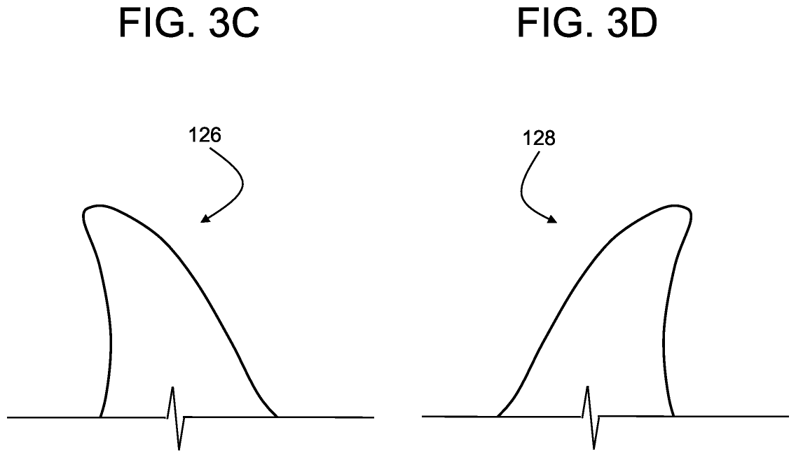

In one exemplary embodiment hereof, the thumb portion 104 extends forward from the hand grip portion 102 a distance that may accommodate the thumb of the user's hand. The thumb portion 104 is formed and adapted to provide ergonomic support to the user's thumb (e.g., the thumbprint area of the thumb) when in use. The lower surface 120 (shown in FIG. 3) of the thumb portion 104 may be smooth or textured and may generally follow the proper curvature to comfortably and ergonomically support the user's thumb. In this way, the user of the device 10 may use his/her thumb to apply downward pressure to the thumb portion 104 and to the massage ridges beneath (as will be described in other sections).

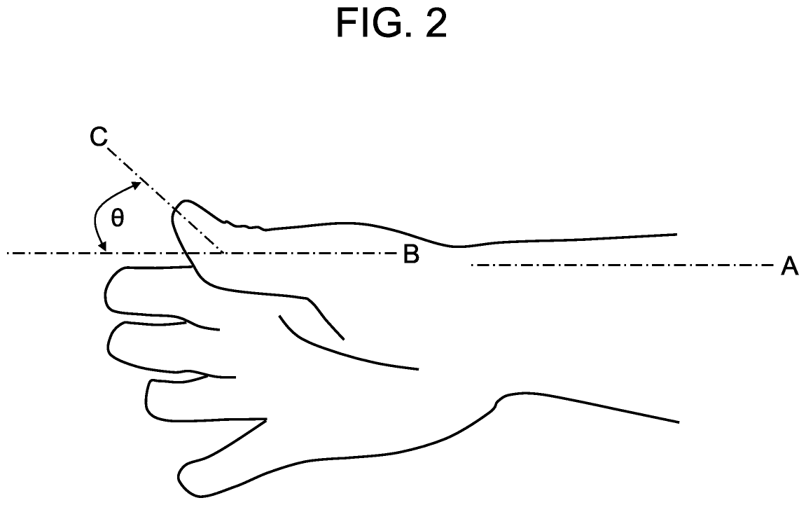

The proper ergonomic alignment of the user's arm and hand for applying thumb pressure to a recipient during a massage is shown in FIG. 2. As shown, the user's arm and hand may preferably be held with the user's radius bone (represented by line A) generally aligned parallel with the user's thumb (the thumb's metacarpal, proximal phalange and medial phalange as represented by line B). The distal phalange of the thumb (represented by line C) is preferably held at a 45° angle (θ) with respect to the radius bone (line A) and the thumb's metacarpal, proximal phalange and medial phalange (line B).

Accordingly, as shown in FIG. 3, the device 10 is structured to support the user's arm, hand and thumb in the proper ergonomic positions as described. As shown, the thumb portion 104 is oriented with respect to the hand grip portion 102 such that when the user grips the hand grip portion 102 with his/her hand, his/her radius bone (line A) is generally aligned parallel to his/her thumb (the thumb's metacarpal, proximal phalange and medial phalange as represented by line B), and the thumb's distal phalange (line C) is supported at a 45° angle (θ) by the sloping curvature of the thumb portion's bottom surface 120. That is, the curvature of the bottom surface 120 transitions within the thumb portion 104 from aligning generally parallel to line B to aligning generally parallel to line C.

In another embodiment as shown in FIG. 3A (a cutaway schematic to show the user's thumb within the inner thumb cavity 124 and the user's fingers on the hand grip portion 102), the hand grip portion 102 and the thumb portion 104 are arranged such that the line B generally bisects the hand grip portion 102 along its transverse plane and serves as a longitudinal axis of the hand grip portion 102. As shown, the thumb portion 104 is oriented with respect to the hand grip portion 102 such that when the user grips the hand grip portion 102 with his/her hand, his/her radius bone (line A) is generally aligned parallel to his/her thumb (the thumb's metacarpal, proximal phalange and medial phalange as represented by line B), and the thumb's distal phalange (line C) is supported at a 45° angle (θ) by the sloping curvature of the thumb portion's bottom surface 120. With this precise structure achieved by the user, a rocking motion may be transferred correctly from the forearm into the 45 degree slope of the distal phalange so that the emanating ridges can execute a leveraged “cross-fiber” penetration into the muscle.

By aligning and supporting the user's thumb (the thumb's metacarpal, proximal phalange and medial phalange as represented by line B) with the user's radius bone (line A), and by aligning and supporting the user's thumb's distal phalange (line C) at a 45° angle (θ) with respect to the thumb (line B) and the radius bone (line A), proper massage arm/hand/thumb ergonomics is achieved. In this way, the device 10 facilitates the application of downward pressure through the device 10 to the massage recipient while minimizing stress to the user's arm, hand and thumb.

It is understood that the thumb portion 104 may be adapted to support the user's thumb's distal phalange (line C) at any angle as necessary, and that the angle θ of 45° as described in the above example is meant for demonstration. For example, the thumb portion 104 may support the user's thumb's distal phalange at 30°-35°, 35°-40°, 40°-45°, 45°-50°, 50°-55°, 55°-60° and at other angles. It is also understood that the scope of the device 10 is not limited in any way by the angle at which the thumb portion 104 may support the user's thumb's distal phalange.

A person of ordinary skill in the art will appreciate that the architecture of the device 10 as described above holds the user's arm(s), hand(s) and thumb(s) in the proper orientation and position for the proper use of the device 10. It is also understood that by using the device 10, the user will be guided to orient his/her arm(s), hand(s) and thumb(s) in the proper orientation for proper massage technique for manual scar tissue eradication even without use of the device 10. This proper arm/hand/thumb alignment is often counterintuitive, and the vast majority of massage therapists may never achieve this proper alignment, leading to a reduction in efficiency in manual techniques as well the development of arthritis in the joints of the therapists' hands and thumbs Accordingly, in some embodiments the device 10 is used to train the user the proper orientation of his/her arm/hand/thumb during manual scar tissue eradication (and other types of massage therapies) for when not using the device 10. In this way, the device 10 is a massage hand trainer.

In another embodiment, the device 10 includes an outside layer of rubber (e.g., a thin layer of silicon or other appropriate material) that provides a slight cushion and/or grip to the device 10. By holding the device 10 as described above while in use, the device 10 may thereby be used to strengthen the user's hands and/or thumbs. In this way, the device 10 is a massage hand strengthener. In some embodiments, the device 10 (e.g., the hand grip portion) includes ergonomic contours that facilitate the proper ergonomic handling of the device 10.

In one exemplary embodiment hereof, the thumb portion 104 includes an upper support 122 that forms an inner thumb cavity 124 with relation to the bottom surface 120. The inner thumb cavity 124 (also referred to as the thumb tunnel) is adapted to receive the user's thumb while in use. The cavity 124 may enclose the entirety of the user's thumb while in use, or any portion thereof, without obstructing the thumb. As will be described in other sections, the upper support 122 may be configured with the attachment system 300.

In one exemplary embodiment hereof as shown in FIG. 3B, the device's hand grip portion 102 includes an upper side ridge 126 and/or a lower side ridge 128, each generally located on the hand grip portion's left side 114 (for a right-handed oriented device 10) and/or right side (for a left-hand oriented device 10). For the purposes of this specification, the upper and lower side ridges 126, 128 will be described with respect to a right-handed oriented device 10 and with the side ridges 126, 128 positioned on the left side 114. However, it is understood that the details described may also pertain to a left-handed oriented device 10 with the side ridges 126, 128 positioned on the right side 116. In some embodiments, side ridges 126, 128 on the right side 116 may mirror the described side ridges 126, 128 on the left side. In some embodiments, both the left and right sides 114, 116 may include side ridges 126 and/or 128.

In some embodiments, the upper side ridge 126 extends generally along the upper perimeter of the hand grip portion 102 from the back 110 to a distance towards the front 108 (e.g., 2″-4″) as shown. In some embodiments, the lower side ridge 128 extends generally along the lower perimeter of the hand grip portion 102 from the back 110 to a distance towards the front 108 (e.g., 2″-4″) as shown. For left-handed oriented devices 10, the upper and lower side ridges 126, 128 may be located in similar positions on the right side 116 of the device 10.

In some embodiments as shown in FIG. 3B, the device's hand grip portion 102 includes a downward extending bottom handle ridge 130 with a generally concave front-side curvature and a generally convex back-side curvature. The bottom handle ridge 130 may extend downward a distance of about 0.5″ to about 2.0″ and preferably about 1.0″.

As is known in the art, there exists a variety of different ecotypes of Orcinus orcas in nature (also known as Killer Whales or simply Orcas), with each type Orca having a highly distinctive dorsal fin shape. For example, it is known that in the North Pacific there are at least five distinct ecotypes of Killer Whales, including Resident, Bigg's, Offshore, Type 1 Eastern North Atlantic and Type 2 Eastern North Atlantic, with each ecotype having a highly distinctive dorsal fin shape. In addition, male and female Killer Whales may have distinctively different shaped dorsal fins compared with one another.

In some embodiments as shown in FIGS. 3C and 3D, the upper side ridge 126 has a cross-sectional shape (from the perspective of cut-lines P-P in FIG. 3B) of a Type 1 Eastern North Atlantic female Orca dorsal fin, and the lower side ridge 128 has a cross-sectional shape (from the perspective of cut-lines Q-Q in FIG. 3B) of a Type 1 Eastern North Atlantic female Orca dorsal fin. In other embodiments, the upper side ridge 126 has the cross-sectionals shape depicted in FIG. 3D, and the lower side ridge 128 has a cross-sectional shape depicted in FIG. 3C.

In some embodiments, the bottom handle ridge 130 has a cross-sectional shape of a Type 1 Eastern North Atlantic female Orca dorsal fin.

In other embodiments, the upper side ridge 126 and/or the lower side ridge 128 and/or the bottom handle ridge 130 have cross-sectional shapes modeled after the Offshore female, the Type 2 Eastern North Atlantic female Killer Whales, the Bigg's female and/or the Resident female Killer whales. In other embodiments, the cross-sectional shapes of the top and bottom side ridges 126, 128 and/or the bottom handle ridge 130 may be modeled after other Orca ecotypes not mentioned here.

In other embodiments, the upper side ridge 126 and/or the lower side ridge 128 and/or the bottom handle ridge 130 include cross-sectional shapes that are the same and/or similar to the cross-sectional shapes of the first and second ridges 202-1, 202-3 as described in other sections. That is, all of the descriptions of the first and second ridges 202-1, 202-3 with regards to their shape and/or form also may be applied to the upper and lower side ridges 126, 128 and/or the bottom handle ridge 130. In addition, all of the descriptions of the upper and lower side ridges 126, 128 herein with respect to their shape and form may be applied to the first and second ridges 202-1, 202-3. In some embodiments, the height of the ridges 126 and/or 128 may be about 0.5″.

In use, the upper and lower side ridges 126, 128 and/or the bottom handle ridge 130 are pressed onto portions of the person's body receiving the massage for the removal of scar tissue adhesions and for peripheral nerve stretching. The ridges 126, 128, 130 may be used in a similar fashion as the thumb portion ridges 202. The user of the device 10 may therefore decide, given the contour of the client's body at any particular angle, which techniques are more ergonomically efficient between using the thumb portion ridges 202 and/or the upper and lower side ridges 126, 128 and/or the bottom handle ridge 130. The same is true for the rear tab 304, which can be utilized in similar fashion with direct downward pressure. Note that all of the descriptions of the first and second ridges 202-1, 202-3 herein with regards to their shape and/or form also may be applied to rear tab 304.

Underside Ridge Portion

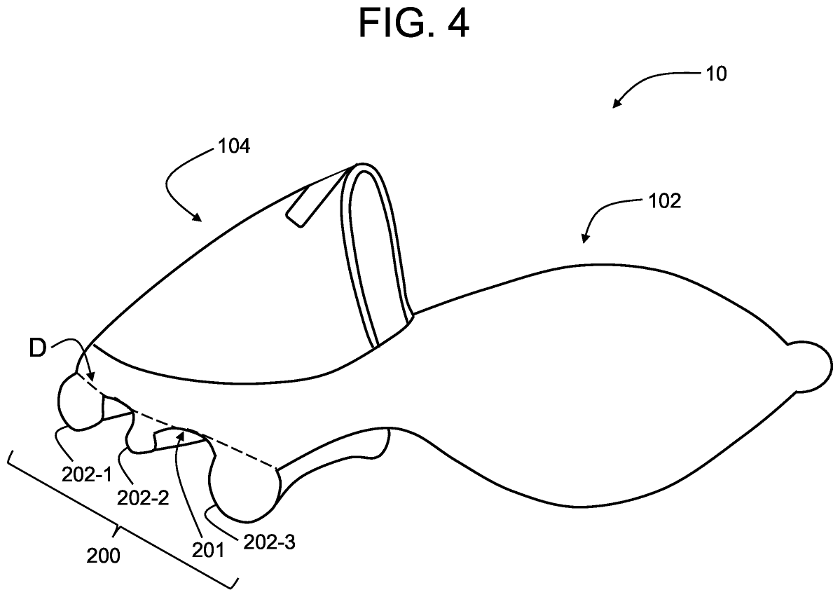

In one exemplary embodiment hereof as shown in FIG. 4, the underside ridge portion 200 is configured generally on the underside of the thumb portion 104. The ridge portion 200 may include an underside surface 201 (represented by line D) from which one or more underside ridges 202 may extend outward. In some embodiments, the ridges 202 may be referred to as projections and/or teeth that extend outward from the surfaces 201. Each ridge 202 may include a proximal end configured with the surface 201 and a distal end extending outward from the ridge's proximal end and away from the surface 201.

In some embodiments, during use, downward and crossward pressure applied by the user's thumb and hand to the thumb portion 104 (and grip portion 102) while using the device 10 is transferred to the underside ridge portion 200. The underside ridge portion 200 is placed into physically contact with the bodily tissues of the massage recipient to facilitate the massage.

In one exemplary embodiment hereof, the downward extending ridges 202 (also referred to as projections or teeth) extend downward generally perpendicular to the longitudinal axis of the handle portion 100 (defined as the axis that extends from the back 110 of the handle portion 100 to the front 108 of the handle portion 100). In other embodiments the downward extending ridges 202 (also referred to as projections or teeth) extend downward at an offset angle with respect to the longitudinal axis of the handle portion 100 (e.g., at 45° with respect to the longitudinal axis). In other embodiments as shown in FIG. 3A, the ridges 202 (also referred to as projections or teeth) may extend in a direction that is generally aligned with (generally parallel or slightly offset from parallel) the front 108 to back 110 longitudinal axis of the handle portion 100.

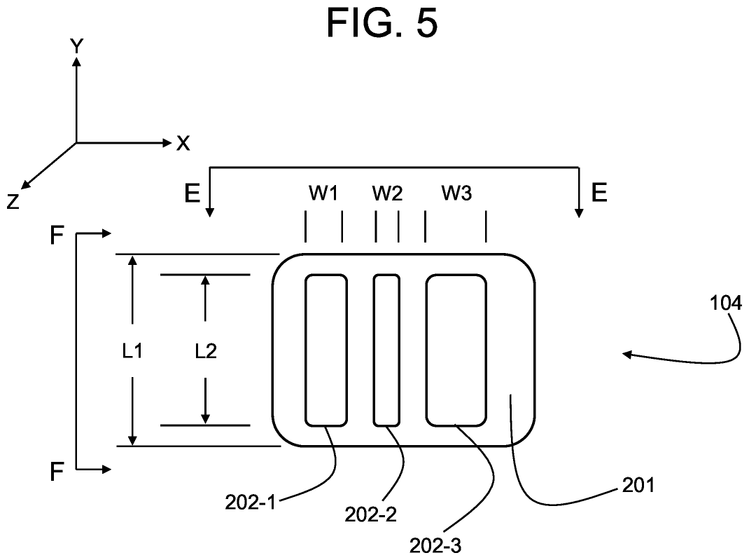

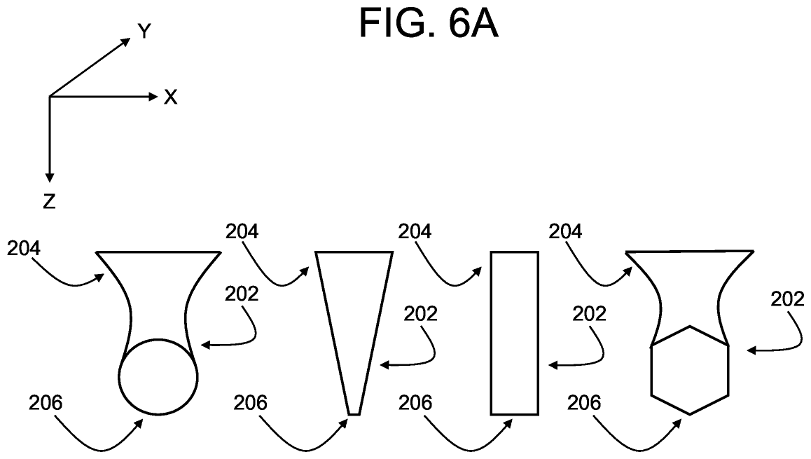

In one exemplary embodiment hereof as shown in FIGS. 4 and 5, the underside ridge portion 200 includes three individual ridges 202-1, 202-2 and 202-3 (collectively and individually 202). In one embodiment, the ridges 202 are generally aligned sequentially along the X-axis (from left to right) in a single row as shown in FIG. 5. In some embodiments, the width W2 of ridge 202-2 is less than the widths W1 of ridge 202-1 and W3 of ridge 202-3. In one embodiment, the width W1 of ridge 202-1 is less than the width W3 of ridge 202-3 (W2<W1<W3). However, it is understood that the widths W1, W2 and W3 may be of any proportion with respect to one another for different purposes. For example, any of the widths W1, W2, W3 may be equal with any other widths W1, W2, W3. In one embodiment, the lengths (along the Y-axis) of the ridges 200 may be the same or similar (may generally match), different (may generally not match) or any combination thereof. In addition, the lengths (along the Y-axis) of the ridges 202 may be the same, similar or different than the dimension of the thumb portion 104 along the Y-axis in the area of the ridges 202. In some embodiments, the width L1 of the thumb portion 104 (of FIG. 5) is about 1″ and the length L2 of the ridges 202 (of FIG. 5) is about 0.75″. Other values of L1 and L2 may also be used.

In some embodiments, the widths W1, W2 and W3 may be 1/16″- 3/16″, 1/32″-⅛″, ⅛″-¼″, respectively. In some embodiments, the widths W1, W2, W3 may be 1/32″-¼″, 1/32″-¼″, 1/16″-⅜″, respectively. In some embodiments, the widths W1, W2, W3 may be ⅛″, 1/16″ and 3/16″ respectively. In some embodiments, the widths W1, W2, W3 may be 3/16″, ⅛″ and ¼″, respectively. It is understood that the example widths shown above for W1, W2 and W3 are meant for demonstration purposes and that the widths W1, W2, W3 (as well as the widths Wn of any other ridges 200-n) may be any dimension as required by the device 10, and that the scope of the device 10 is not limited in any way by the width dimensions of the ridges W1, W2, W3, . . . Wn.

In one embodiment, the spacing between the ridges 202 (e.g., between ridge 202-1 and 202-2, and between 202-2 and 202-3) may be the same or similar (may generally match), different (may generally not match) or any combination thereof. In some embodiments, the spacing between the ridges 202 may be 0-1.0 inches. For example, in some embodiments, the spacing between the ridge 202-1 and the ridge 202-2 may be ⅜″-¾″. In other embodiments, the spacing between the ridge 202-1 and the ridge 202-2 may be ½″, ⅝″, ¾″ or other spacings. In some embodiments, the spacing between the ridge 202-2 and the ridge 202-3 may be ½″-1″. In other embodiments, the spacing between the ridge 202-2 and the ridge 202-3 may be ⅝″, ¾″, ⅞″ or other spacings. It is understood that the distances between the ridges 202-1 and 202-2, and between 202-2 and 202-3, and between the ridges 202-1, 202-2, 202-3 and any other ridges 202-n may include any distances depending on the desired application of the device 10 and that the scope of the device 10 is not limited in any way by the spacings between any of the ridges 202.

In some embodiments hereof, the ridges 202 may be generally linear with constant widths along the Y-axis. In other embodiments, the ridges 202 may include curvatures or varying widths along the Y-axis. In other embodiments, some of the ridges 202 may be linear with constant widths along the Y-axis while other ridges 202 may include curvatures or varying widths along the Y-axis. For example, some of the ridges 202 may include an arc shape.

In some embodiments, one or more of the ridges 202 may be parallel with respect to one or more other ridges 202. In other embodiments, one or more of the ridges 202 may be non-parallel with respect to one or more other ridges 202.

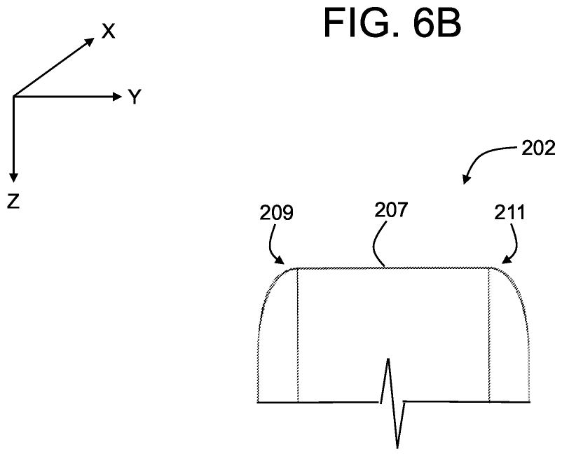

FIG. 6A shows exemplary cross-sections of the ridges 202 taken along cut-lines E-E of FIG. 5. The ridges 202 may include a base 204 (proximal end) generally configured with the underside surface 201 (line D) and a tip 206 (distal end). Any of the ridges 202 may include any type of cross-sectional shape as required. The cross-sectional shapes of each ridge 202 may be designed for the purposes of the types of massages, muscle treatments, nerve treatments and other design criteria of the device 10. As shown, some of the ridges 202 may include rounded tips, pointed tips, flat tips, multi-angular tips, other types of tips and any combination thereof. The cross-sectional shapes of the ridges may generally match or may be different. The cross-sectional shapes of the ridges 202 may also vary along the Y-axis (e.g., in shape, in size, in length (e.g., along the Z-axis), etc.).

It is understood that the cross-sectional shapes shown in FIG. 6A are meant for demonstrational purposes and that any of the ridges 202 may include other types of cross-sectional shapes or combinations of cross-sectional shapes not necessarily shown. It is also understood that the scope of the device 10 and of the ridges 202 is not limited in any way by the type of cross-sectional shape that each or any of the ridges 202 may include.

In addition, in some embodiments, the lengths of the ridges 200 (along the Z-axis of FIG. 6A) may be any suitable length, for example, ⅛″-2″. In some embodiments, the length of the ridges 200 (along the Z-axis of FIG. 6) may be about 1″. The lengths of the ridges 200 may or may not match one another, and it is understood by a person of ordinary skill in the art that the ridges 200 may have any suitable lengths (along the Z-axis of FIG. 6) and that the scope of the device 10 is not limited in any way by the lengths of the ridges 200.

In some embodiments, as shown in FIG. 6A, the downward angle of the ridges 202 may be generally perpendicular with respect to the underside surface 201 (represented by line D in FIG. 4) and/or the user's thumb's distal phalange (line C of FIG. 3) when in use.

FIG. 6B shows a ridge 202 from the perspective of cut-lines F-F of FIG. 5. As shown, tip 206 (at the ridge's distal end) may be formed as a blade 207 that extends from the ridge's left side 209 to its right side 211. The blade 207 of FIG. 6B is defined as an upper-most edge of the ridge 202. As will be described in other sections, the blade 207 may be oriented to point in a specific direction with respect to the overall ridge 202.

In some embodiments, the blade 207 extends generally linearly from its left side 209 to its right side 211. In other embodiments, the blade 207 includes a curvature from its left side 209 to its right side 211. For example, the blade 207 may include a convex, concave, parabolic, other types of curvatures from its left side 209 to its right side 211, and any combinations thereof.

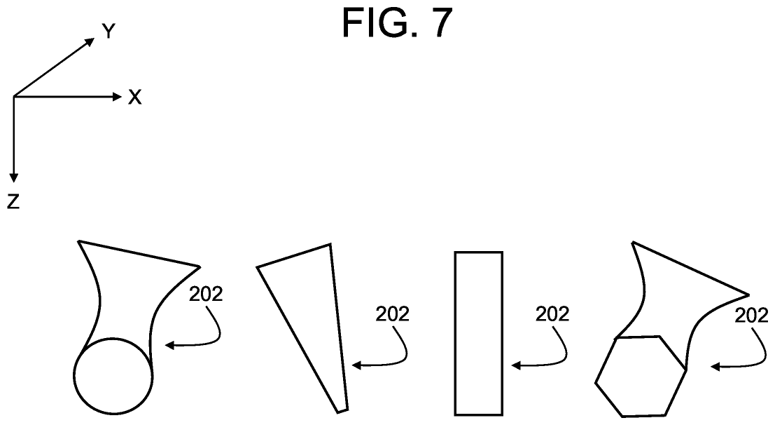

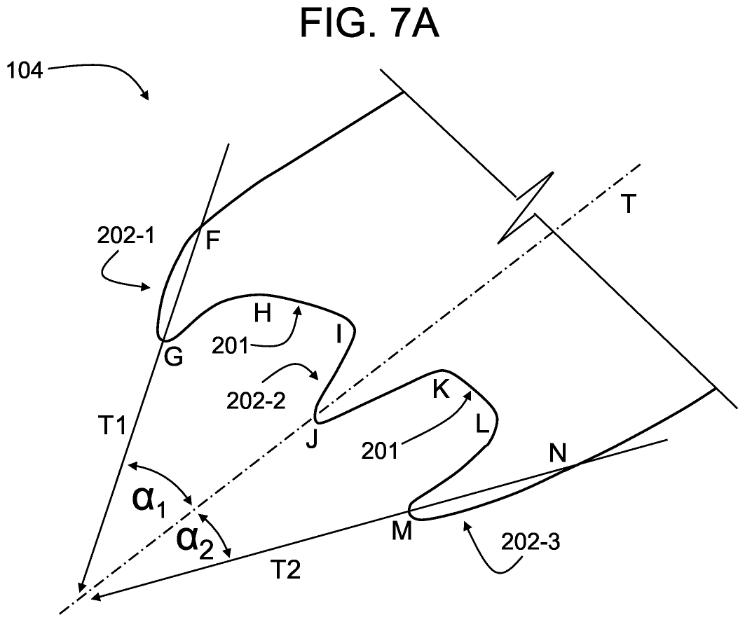

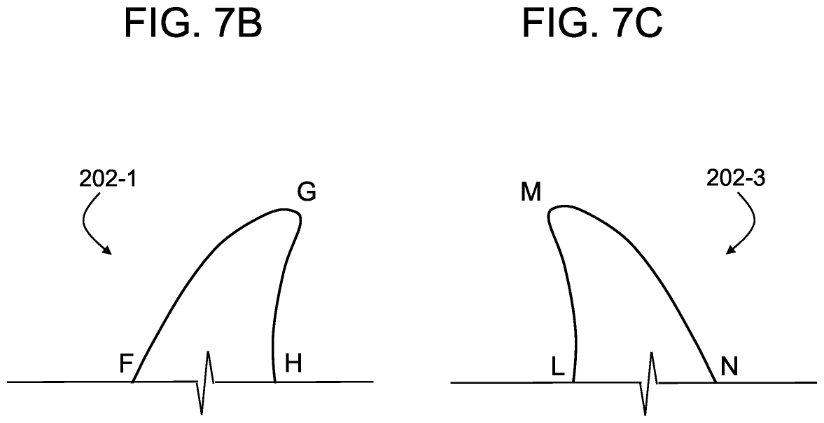

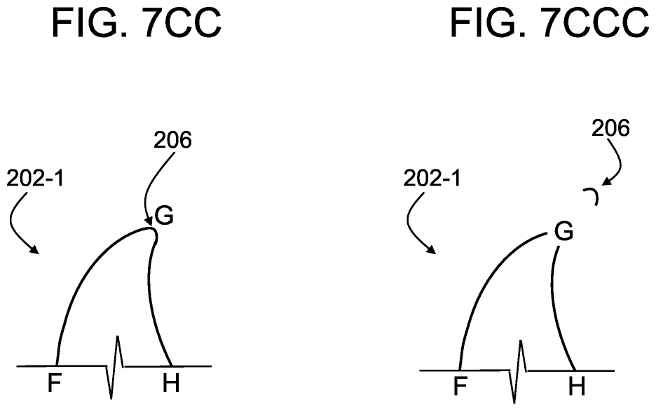

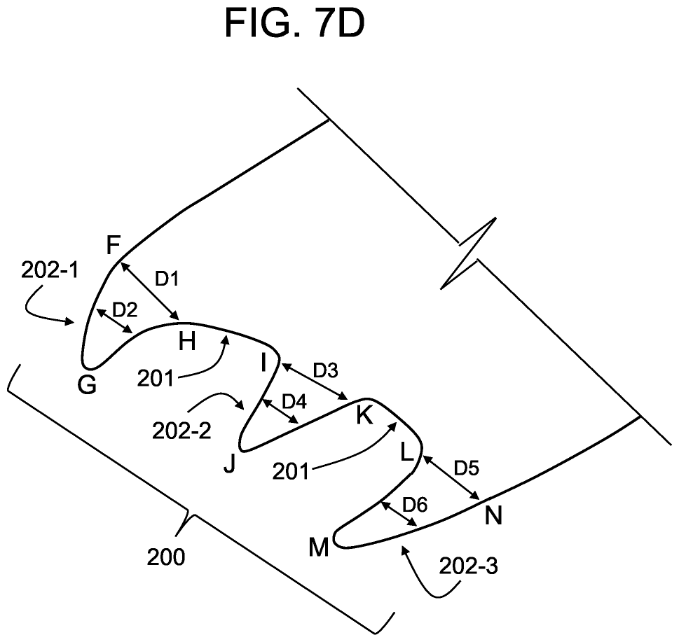

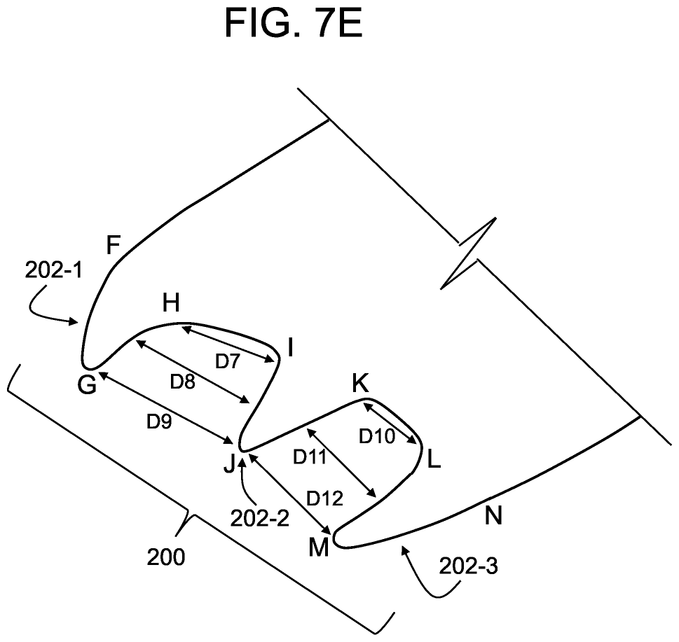

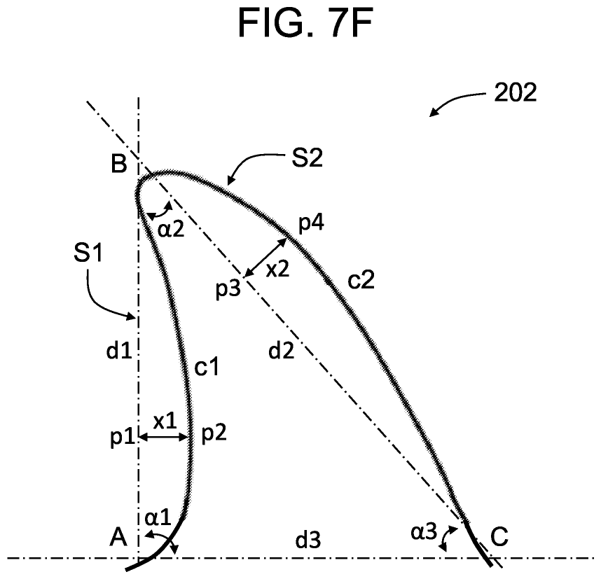

As shown in FIG. 7, any of the ridges 202 may be placed at any offset angle with respect to the underside surface 201 and/or the thumb's distal phalange. It is understood that the angular offsets shown in FIG. 7 are meant for demonstrational purposes and that the ridges 202 may be offset at any angle. In addition, each ridge's angular offset need not match any other ridge's angular offset, but they may as desired. It is understood that the scope of the device 10 and of the ridges 202 is not limited in any way by the angle at which any of the ridges 202 may extend.

It is understood by a person of ordinary skill in the art, upon reading this specification, that while the example described above includes a total of three ridges (202-1, 202-2, 202-3) included on the ridge portion 200, the ridge portion 200 may include any number of ridges 202-n as desired. For example, the ridge portion 200 may include one ridge 202, two ridges 202, four ridges 202, five ridges 202, six ridges 202 and other numbers of ridges 202. It is also understood that the scope of the device is not limited in any way by the number of ridges 202 that may be included in the ridge portion 200.

In addition, the ridge portion 200 may extend beyond the underside of the thumb portion 104 to the underside of the hand grip portion 102 such that ridges 202 may also be positioned beneath the hand grip portion 102. Note also that while the example described above shows the ridges 202 generally positioned on the bottom 112 of the handle portion 100, ridges 202 also may be positioned on (or extend onto) other areas of the handle portion 100 such as the front 108, the back 110, the left side 114, the right side 116 and any combination thereof.

FIG. 7A shows a cross-sectional view of the ridge portion 200 and the three individual ridges 202-1, 202-2 and 202-3 configured with the thumb portion 104 according to exemplary embodiments hereof. FIGS. 7B and 7C show the cross-sectional views of ridges 202-1 and 202-3, respectively.

The outer surface of the cross-section of ridge 202-1 is generally defined as the surface portion that extends from point F to point G to point H, the outer surface of the cross-section of ridge 202-2 is generally defined as the surface portion that extends from point I to point J to point K, and the outer surface of the cross-section of ridge 202-3 is generally defined as the surface portion that extends from point L to point M to point N. The distal end of ridge 202-1 includes a tip 206 and/or a blade 207 located at point G, the distal end of ridge 202-2 includes a tip 206 and/or a blade 207 located at point J, and the distal end of ridge 202-3 includes a tip 206 and/or a blade 207 located at point M.

In some embodiments, the outer surface of the cross-section of ridge 202-1 that extends from F to G (referred to herein as portion F-G) includes a convex curvature arcing from F to G, and the outer surface of the cross-section of ridge 202-1 that extends from G to H (referred to herein as portion G-H) includes a concave curvature arcing from G to H. In some embodiments, the portions F-G and G-H may include partial parabolic curvatures. In some embodiments, the portions F-G and G-H include smooth arcing curvatures. In some embodiments, the portions F-G and G-H include converging linear portions angled accordingly.

In some embodiments, the outer surface of the cross-section of ridge 202-2 that extends from I to J (referred to herein as portion I-J) includes a curvature arcing from I to J, and the outer surface of the cross-section of ridge 202-2 that extends from J to K (referred to herein as portion J-K) includes a curvature arcing from J to K. In some embodiments, the portions I-J and J-K may include partial parabolic curvatures. In some embodiments, the portions I-J and J-K include smooth arcing curvatures. In some embodiments, the portions I-J and J-K include converging linear portions angled accordingly as shown in FIG. 7A.

In some embodiments, the outer surface of the cross-section of ridge 202-3 that extends from N to M (referred to herein as portion N-M) includes a convex curvature arcing from N to M, and the outer surface of the cross-section of ridge 202-3 that extends from M to L (referred to herein as portion M-L) includes a concave curvature arcing from M to L. In some embodiments, the portions N-M and M-L may include partial parabolic curvatures. In some embodiments, the portions N-M and M-L include smooth arcing curvatures. In some embodiments, the portions N-M and M-L include linear portions angled accordingly.

In some embodiments, the arcing concave surface portion G-H and the arcing concave surface portion M-L are opposing. In some embodiments, the arcing concave surface portion G-H and the arcing concave surface portion M-L mirror one another.

In some embodiments, the tips G, J and M of the ridges 202-1, 202-2 and 202-3, respectively, may be generally rounded, pointed, and/or may include other cross-sectional shapes as described in other sections.

It is recognized that the portion F-G and the portion G-H may generally converge at a tip portion 206 (or blade 207) at G, and that the tip portion 206 at G may include a curvature that connects the upper end of the portion F-G with the upper end of the portion G-H. Accordingly, and for clarity, FIG. 7CC shows the ridge 202-1 represented by portions F-G and G-H, and FIG. 7CCC shows the ridge 202-1 with the tip portion 206 separated (illustratively) from the portions F-G and G-H to clearly show the convex arcing curvature of portion F-G and the concave arcing curvature of portion G-H. Note that in some embodiments, the length of portion F-G is greater than the length of portion G-H. For example, the length of portion F-G may be about 5%-20% longer than the length of portion G-H. It is understood that the curvatures represented in FIGS. 7CC and 7CCC also apply to the convex arcing curvature of portion N-M and the concave arcing curvature of portion M-L of ridge 202-3 (albeit possibly mirrored), as well as the respective convex and concave curvatures of ridges 126, 128, and 130.

As shown in FIG. 7A, transverse axis T generally bisects the depicted portion of the thumb portion 104 generally along the portion's transverse plane. Axis T1 passes through points F and G of ridge 202-1 and forms an angle α₁ with respect to transverse axis T, and axis T2 passes through points N and M of ridge 202-3 and forms an angle α₂ with respect to transverse axis T. The axis T1 and T2 are each angled inwardly towards one another such that each axis T1 and T2 converge with axis T. In this way, the top ridge 202-1 is generally angled downward along its form, and the bottom ridge 202-3 is generally angled upward along its form as shown. That is, the blade 207 of the top ridge 202-1 is angled downward, and the blade 207 of the bottom ridge 202-3 is angled upward. Accordingly, the top ridge 202-1 and the bottom ridge 202-3 may be generally angled inward with respect to the transverse axis T and towards one another. In some embodiments, the first ridge 202-1 and the third ridge 202-3 may be generally opposing and/or may generally mirror one another.

In some embodiments, α₁ may range from 1°-89° and preferably from about 20°-60°. In some embodiments, α₂ may range from 1°-89° and preferably from about 20°-60°. Note that α₁ and α₂ may or may not match.

In general, ridge 202-1 may include a curvature starting at its base (F-H) arcing downward at an inward angle to its tip G, and ridge 202-3 may include a curvature starting at its base (N-L) arcing upward at an inward angle to its tip M.

In one exemplary embodiment hereof, the outer surface contour of the cross-section of ridge 202-1 is modelled as an Orca dorsal fin shape (viewed from the side). In some embodiments, the outer surface contour of the cross-section of ridge 202-1 is more specifically modelled as a dorsal fin shape (viewed from the side) of the Type 1 Eastern North Atlantic female (as shown in FIG. 7B), the Offshore female, and/or the Type 2 Eastern North Atlantic female Killer Whales. In another embodiment, the outer surface contour of the cross-section of ridge 202-1 is more specifically modelled as a dorsal fin shape (viewed from the side) of the Bigg's female and/or the Resident female Killer whales. In other embodiments, the outer surface contour of the cross-section of ridge 202-1 may be modeled after other Orca ecotypes not mentioned here.

In one exemplary embodiment hereof, the outer surface contour of the cross-section of ridge 202-3 is modelled as an Orca dorsal fin shape (viewed from the side). In some embodiments, the outer surface contour of the cross-section of ridge 202-3 is more specifically modelled as a dorsal fin shape (viewed from the side) of the Type 1 Eastern North Atlantic female (as shown in FIG. 7C), the Offshore female, and/or the Type 2 Eastern North Atlantic female Killer Whales. In another embodiment, the outer surface contour of the cross-section of ridge 202-3 is more specifically modelled as a dorsal fin shape (viewed from the side) of the Bigg's female and/or the Resident female Killer whales. In other embodiments, the outer surface contour of the cross-section of ridge 202-3 may be modeled after other Orca ecotypes not mentioned here.

It is noted that in some embodiments the cross-sectional shapes of the ridges 202-1 and 202-3 may match (albeit mirrored), while in other embodiments the cross-sectional shapes of the ridges 202-1 and 202-3 may not match. In this case, each ridge 202-1, 202-3 may be modeled using a different ecotype and/or gender of Orca, and/or using different dimensions. In other cases, one of the ridges 202-1, 202-3 may include an Orca-shaped cross-sectional shape while the other ridge 202-3, 202-1 may include a different cross-sectional shape. It is understood that the cross-sectional shapes of the ridges 202-1, 202-3 may include any combination thereof of any of the shapes described or otherwise.

FIG. 7D shows a cross-sectional view of the ridge portion 200 and the three individual ridges 202-1, 202-2 and 202-3 according to exemplary embodiments hereof. The base width D1 of ridge 202-1 (e.g., between F and H) is generally larger than the midpoint width D2 of ridge 202-1, the base width D3 of ridge 202-2 (e.g., between I and K) is generally larger than the midpoint width D4 of ridge 202-2, and the base width D5 of ridge 202-3 (e.g., between L and N) is generally larger than the midpoint width D6 of ridge 202-3. In some embodiments, the ridges 202-1, 202-2, 202-3 are tapered from their respective bases to their respective tips. In addition, the tips at G, J, and M may be rounded with diameters of about 1/16″⅛″.

In some embodiments, the width D2 is about 60%-90% the width D1, and preferably about 80% the width of D1. In some embodiments the diameter of the tip at G is about 25%-75% the width D2, and preferably about 50% the width of D2. In other embodiments, the diameter of the tip at G is smaller and about 1%-25% the width of D2, and preferably about 5%-10% or about 6% the width of D2.

In some embodiments, the width D6 is about 60%-90% the width D5, and preferably about 80% the width of D5. In some embodiments the diameter of the tip at M is about 25%-75% the width D6, and preferably about 50% the width of D6. In other embodiments, the diameter of the tip at M is smaller and about 1%-25% the width of D6, and preferably about 5%-10% or about 6% the width of D6.

In some embodiments, the width D4 is about 55%-95% the width D3, and preferably about 75% the width of D3. In some embodiments the diameter of the tip at J is about 33%-99% the width D4, and preferably about 67% the width of D4. In other embodiments, the diameter of the tip at J is smaller and about 1%-33% the width of D4, and preferably about 5%-15% or about 10% the width of D4.

In some embodiments, D1 is about ⅛″-1″ and preferably about 5/16″, and D2 is about 1/16″-1″ and preferably about ¼″.

In some embodiments, D3 is about ⅛″-1″ and preferably ¼″, and D4 is about 1/16″-1″ and preferably about 3/16″,

In some embodiments, D5 is about ⅛″-1″ and preferably about 5/16″, and D6 is about 1/16″-1″ and preferably about ¼″,

In some embodiments, the tips G, J, and M are rounded with diameters of about 1/64″-¼″ and preferably about 1/16″-⅛″.

FIG. 7E shows a cross-sectional view of the ridge portion 200 and the three individual ridges 202-1, 202-2 and 202-3 according to exemplary embodiments hereof. The distance D7 between the base (e.g., point H) of ridge 202-1 and the base (e.g., point I) of ridge 202-2 is about ⅜″, the distance D8 between the midpoint of ridge 202-1 and the midpoint of ridge 202-2 is about 7/16″, and the distance D9 between the tip (e.g., point G) of ridge 202-1 and the tip (e.g., point J) of ridge 202-2 is about 9/16″. The distance D10 between the base (e.g., point K) of ridge 202-2 and the base (e.g., point L) of ridge 202-3 is about ⅜″, the distance D11 between the midpoint of ridge 202-2 and the midpoint of ridge 202-3 is about 7/16″, and the distance D12 between the tip (e.g., point J) of ridge 202-2 and the tip (e.g., point M) of ridge 202-3 is about 9/16″.

It is understood that the dimensions shown above are meant for demonstration and that the measurements D1-D12 may include other values as required by the device 10.

In one exemplary embodiment as shown in FIG. 7F, the cross-sectional shape of a ridge 202 is defined with respect to its comparison with a right-angled triangle. FIG. 7F shows a right-angled triangle defined by the dashed lines extending between point A and point B (line d1), between point B and point C (line d2), and between point C and point A (line d3). For reference, this triangle will be referred to as triangle ABC. FIG. 7F also shows the cross-sectional shape of the ridge 202 overlaid the triangle ABC.

In some embodiments, the cross-sectional shape of the ridge 202 includes a first concave curvature c1 (defining its left side as shown in FIG. 7F) and a first convex curvature c2 (defining its right side as shown in FIG. 7F), with the top of first concave curvature c1 intersecting the top of the first convex curvature c2 at the ridge's top apex generally shown at point B. The blade 207 of the ridge 202 may be located at this top apex. The bottom of the first concave curvature c1 intersects the base line of the ridge 202 (line d3 that passes through points A and C) at point A. The bottom of the first convex curvature c2 intersects the base line of the ridge 202 (line d3 that passes through points A and C) at point C. The resulting cross-sectional shape of the ridge 202 thereby resembles an Orca dorsal fin.

As shown, the shape S1 is generally formed by the combination of line d1 and the curvature c1, and the shape S2 is generally formed by the combination of line d2 and the curvature c2. It can be seen that if the shape S1 were to be flipped vertically that the shape of shape S1 would resemble the shape of shape S2.

The arrow x1 represents the maximum perpendicular distance with respect to the line d1 between the line d1 and the curvature c1, and the arrow x2 represents the maximum perpendicular distance with respect to the line d2 between the line d2 and the curvature c2. The arrow x1 intersects the line d1 at the point p1 and the curvature at point p2. The arrow x2 intersects the line d2 at the point p3 and the curvature c2 at the point p4. The apex of the curvature c1 generally coincides with the point p2 and the apex of the curvature c2 generally coincides with the point p4.

Accordingly, the triangle ABC may be transformed into the cross-sectional shape of the ridge 202 by removing the shape S1 from the triangle ABC, flipping the shape S1 vertically, and overlaying and aligning shape S1′s line d1 onto line d2.

In some embodiments as shown in FIG. 7F, α1 equals about 90°, α2 equals about 30° and α3 equals about 60°. In some embodiments, x1 equals about ( 1/24)(d1) to about ( 3/24)(d1) and preferably about ( 1/12)(d1). In some embodiments, the distance between point B and the point p1 is about ( 5/12)(d1) to about ( 7/12)(d1) and preferably about (½)(d1).

In other embodiments, x1 equals about ( 1/12)(d1) to about ( 3/12)(d1) and preferably about ( 2/12)(d1). In some embodiments, the distance between point B and the point p1 is about ( 7/12)(d1) to about ( 9/12)(d1) and preferably about ( 8/12)(d1).

In some embodiments, x1=x2. In other embodiments, x1=(x2)±(0.1)(x2) to (x2)±(0.3)(x2).

It is understood that the examples described above are meant for demonstration and that the dimensions of the various elements of the ridges 202 may include other values. It also is understood that the descriptions of ridge 202 also may apply to other elements included on the tool 10, such as, without limitation, the upper side ridge 126 and/or the lower side ridge 128 and/or the bottom handle ridge 130.

The Attachment System and the Combined Device Assembly

In one exemplary embodiment hereof, the device 10 may include an attachment system 300 that may facilitate the attachment of two or more devices 10 together to form a multi-device assembly 400.

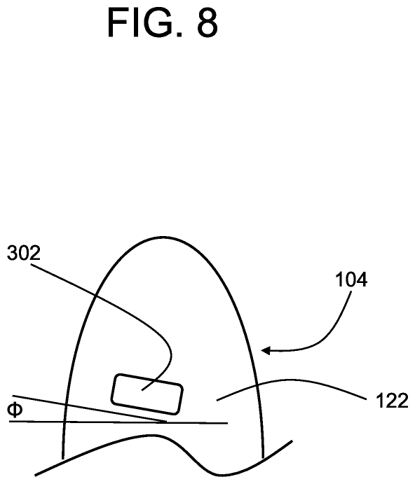

As shown in FIGS. 1 and 8, the attachment system 300 may include an upper slot 302 and a rear tab 304. In one embodiment, the upper slot 302 is configured with the top of the thumb portion's upper support 122 and the rear tab 304 is configured with the back 110 of the handle portion 100. Note that the rear tab 304 may also be used as a massage ridge (similar to ridges 202 but placed at the rear of the handle portion 100).

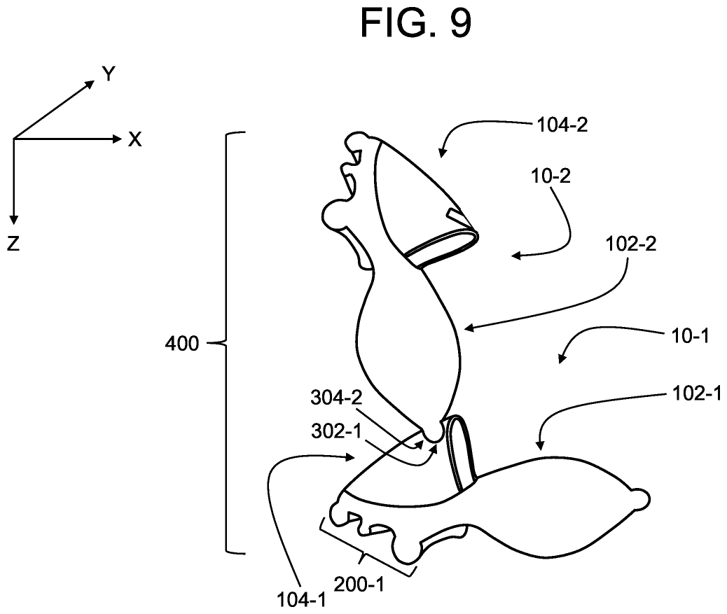

In one exemplary embodiment hereof as shown in FIG. 9, the slot 302-1 of a first device 10-1 is adapted to receive and secure the rear tab 304-2 of a second device 10-2 to form a combined device assembly 400. Accordingly, the slot 302-1 may have a size and shape that may generally correspond to the size and shape of the rear tab 304-2. It is preferable that the rear tab 304-2 may be received and secured within the slot 302-1, and subsequently removed from the slot 302-1, without excessive force. It is also preferable that the rear tab 304-2 be held securely within the slot 302-1 while in use. The rear tab 304-2 may be held securely within the slot 302-1 by pressure fit, detents or other securing techniques.

With the rear tab 304-2 of the second device 10-2 secured within the slot 302-1 of the first device 10-1, the second device 10-2 may be generally positioned upright with respect to the first device 10-1. In this configuration, a user's first hand (e.g., the user's right hand) may grip the hand grip portion 102-1 of the first device's handle portion 100-1 with the right hand thumb extending forward into the thumb portion 104-1. In addition, the user's second hand (e.g., the user's left hand) may grip the hand grip portion 102-2 of the second device's handle portion 100-2. The user's left hand thumb may or may not extend forward into the second device's thumb portion 104-2. In this configuration, the user may grasp the combined device assembly 400 with both hands to facilitate precise control of the assembly 400 and the assembly's lower ridges 202-1 (the ridges 202-1 of the first device 10-1) during use.

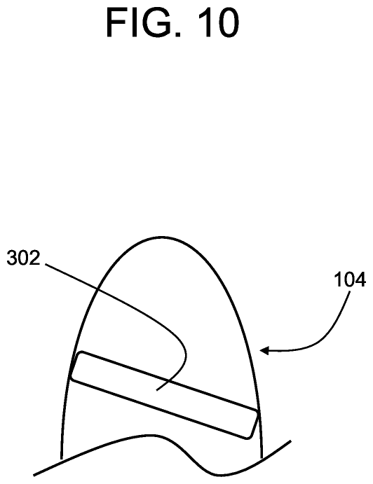

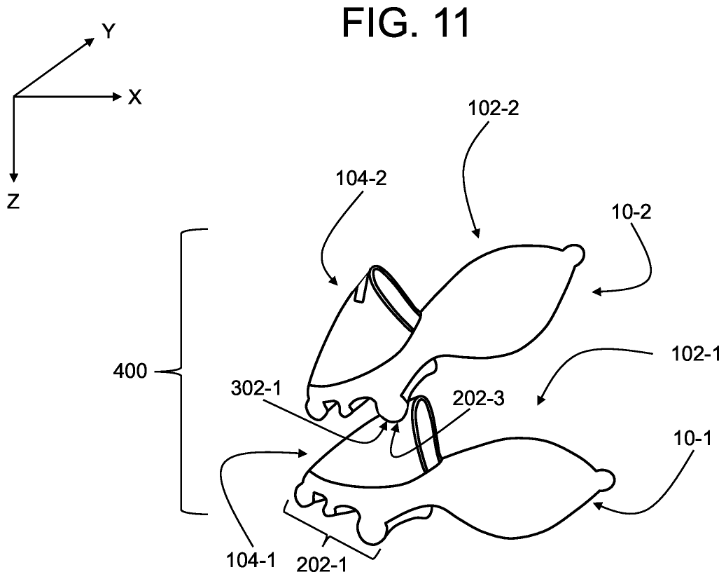

In one exemplary embodiment hereof as shown in FIGS. 10 and 11, the slot 302-1 of a first device 10-1 is adapted to receive and secure the rear tab 304-2 of a second device 10-2 to form a combined device assembly 400. Accordingly, the slot 302-1 may have a size and shape that may generally correspond to the size and shape of the second device's (10-2) ridge 202-3. It is preferable that the ridge 202-3 may be received and secured within the slot 302-1, and subsequently removed from the slot 302-1, without excessive force. It is also preferable that the ridge 202-3 be held securely within the slot 302-1 while in use. The ridge 202-3 may be held securely within the slot 302-1 by pressure fit, detents or other securing techniques.

With the ridge 202-3 of the second device 10-2 secured within the slot 302-1 of the first device 10-1, the second device 10-2 may be generally positioned above and at an upright angle with respect to the first device 10-1. In this configuration, a user's first hand (e.g., the user's right hand) may grip the hand grip portion 102-1 of the first device's handle portion 100-1 with the right hand thumb extending forward into the thumb portion 104-1. In addition, the user's second hand (e.g., the user's left hand) may grip the hand grip portion 102-2 of the second device's handle portion 100-2 with the user's left hand thumb preferably extending forward into the second device's thumb portion 104-2. In this configuration, the user may grasp the combined device assembly 400 with both hands to facilitate precise control of the assembly 400 and the assembly's lower ridges 202-1 (the ridges 202-1 of the first device 10-1) during use.

In some exemplary embodiments hereof, the first and second combined devices 10-1, 10-2 (e.g., the embodiments of FIG. 9 and/or 11) may be angularly offset about the Z-axis. That is, the second device 10-2 may be rotated about an axis perpendicular to the longitudinal axis (defined as the axis extending from the back 110 of the handle 100-1 to the front 108 of the handle 100-1) of the first device 10-1. For instance, as shown in FIG. 8, the slot 302 may be placed at an angle ϕ with respect to the horizontal plane. As such, when the second device 10-2 is engaged with the slot 302, the second device 10-2 will also be placed at an angle of with respect to the same horizontal plane. This offset angle ϕ may allow for the right and left hands of the user to be placed at a more natural position while gripping the first and second devices 10-1, 10-2 (that is, the combined assembly 400).

In some embodiments, the angle ϕ may be about 20°. In other embodiments, the angle ϕ may be 0°, 5°, 10°, 15°, 25°, 30°, 35°, 40°, 45° and other angles. In another example, the angle ϕ may be in the range of 0°-90°. It is understood that the angle ϕ may be any angle as required to place the first and second devices 10-1, 10-2 at ergonomic angles for use.

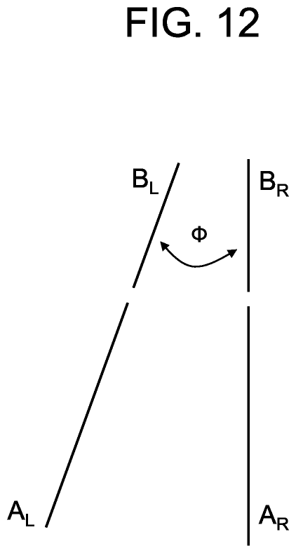

In addition, as shown in FIG. 12, the offsetting of the combined devices 10-1, 10-2 may facilitate the proper orientations of the user's left and right arm, hands and thumbs while using the combined assembly 400. As shown, the user's left radius bone (represented by line A_{L}) may be aligned generally parallel to the user's left thumb (the thumb's metacarpal, proximal phalange and medial phalange as represented by line B_{L}), and the user's right radius bone (represented by line A_{R}) may be aligned generally parallel to the user's right thumb (the thumb's metacarpal, proximal phalange and medial phalange as represented by line B_{R}). In addition, the user's left radius bone and left thumb (lines A_{L} and B_{L}) may be offset from the user's right radius bone and right thumb (lines A_{R} and B_{R}) by the angle ϕ. By properly orientating the user's left and right radius bones and thumbs, the user's arms and hands may provide stable downward pressure to the device 10 while in use while minimizing stress to the user's arms and hands.

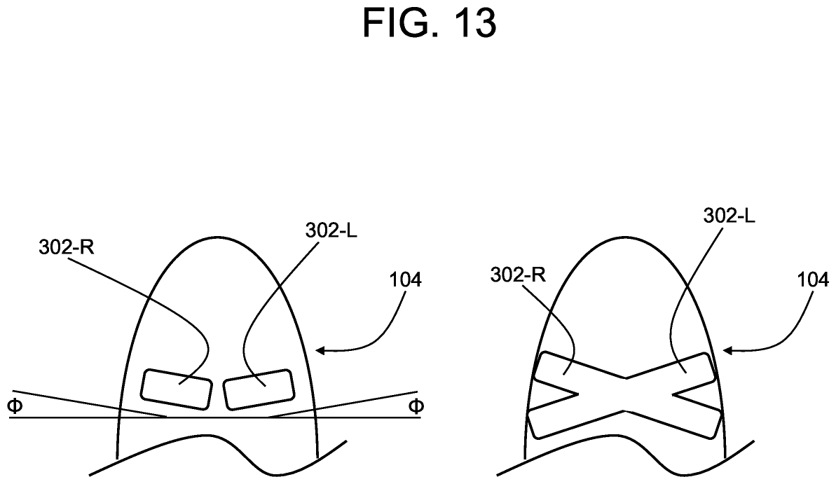

In one exemplary embodiment hereof as shown in FIG. 13, the first device 10-1 may include slots 302-R and 302-L that may be adapted to receive the rear tab 304 or the ridge 202-3 of the second device 10-2 for either a right handed assembly 400 or a left handed assembly 400 respectively. It can be seen that slots 302-R may be similar to slots 302 of FIGS. 8 and 10 for a right-handed user of the combined assembly 400. Accordingly, for a left-handed user of the combined assembly 400, the slots 302-L may be generally mirror images of the slots 302-R. In this way, for a left-handed user, the first and second devices 10-1, 10-2 may be offset by the angle ϕ in the mirrored direction.

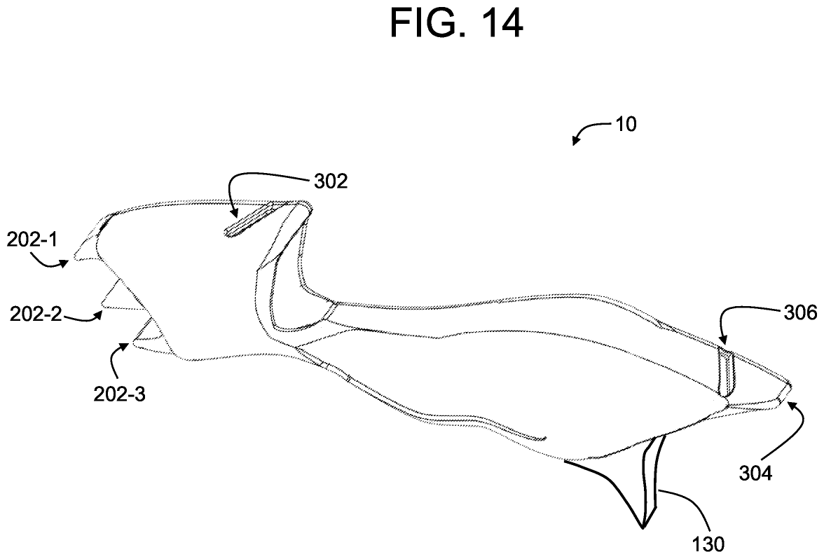

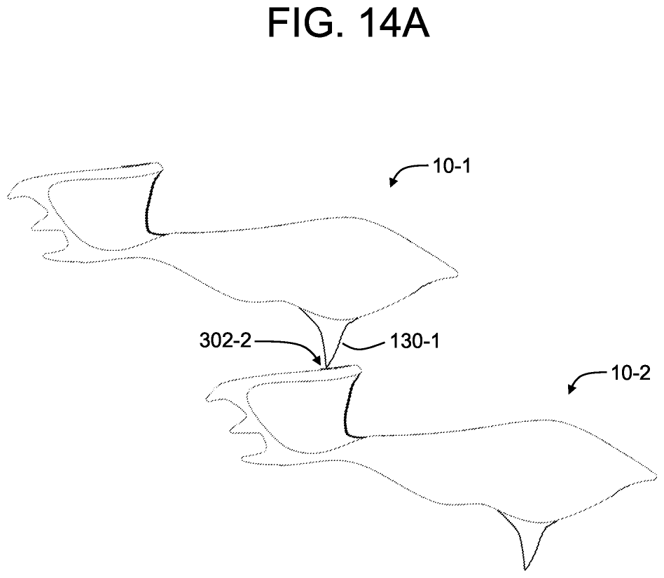

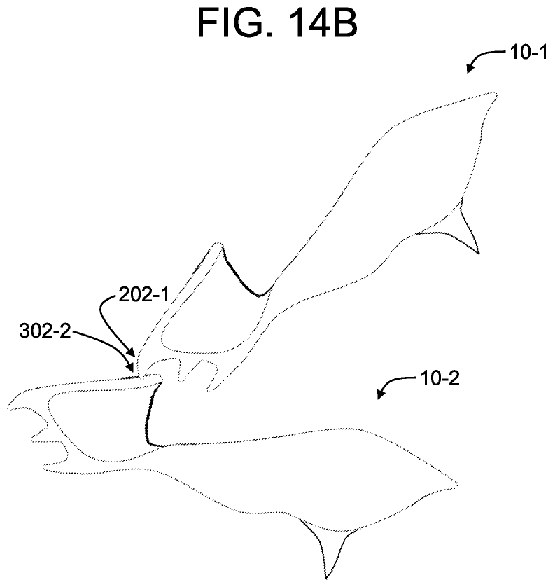

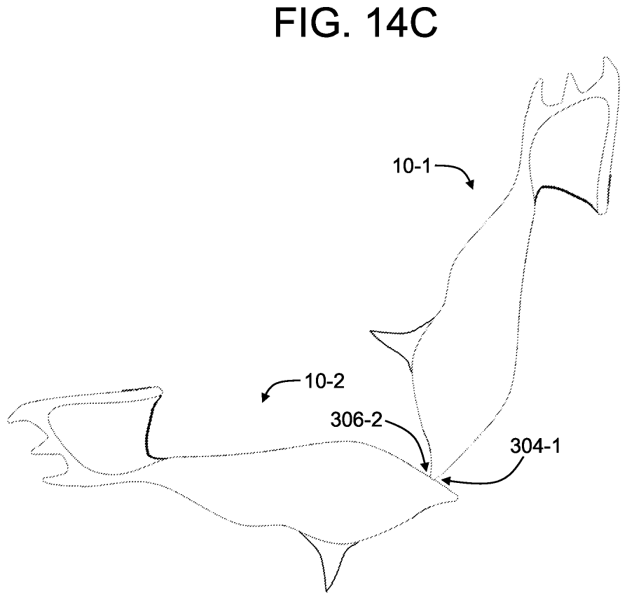

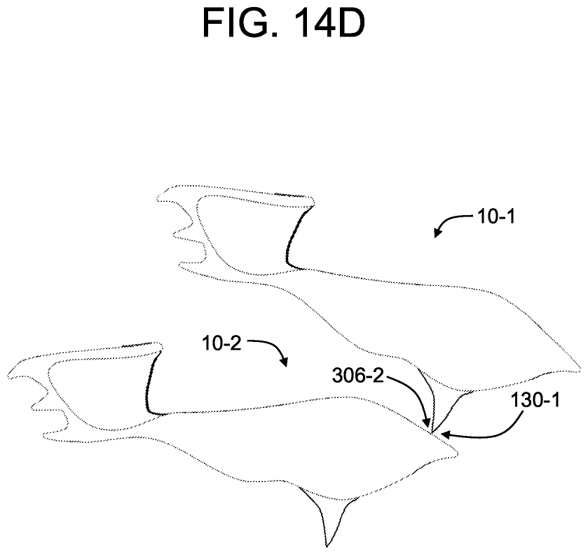

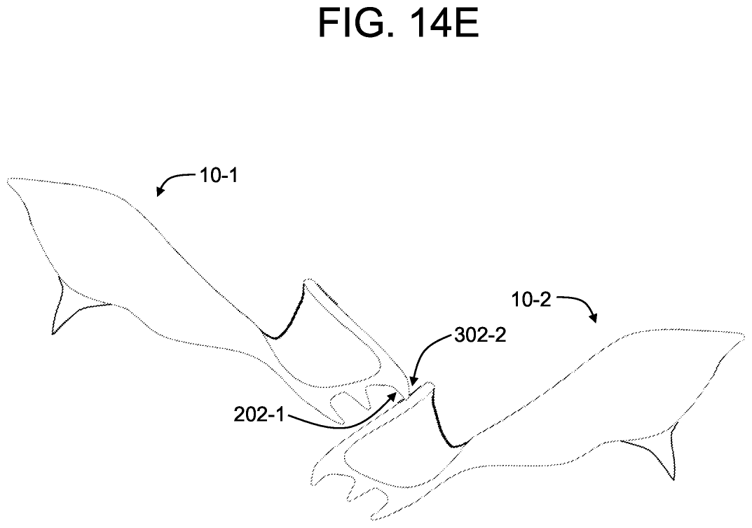

In one exemplary embodiment hereof as shown in FIG. 14, the attachment system 300 may include a rear slot 306. The rear slot 306 may be generally located on the top back 110 of the handle grip portion 102. In some embodiments the rear slot 306 of a first device 10-1 may be adapted to receive the rear tab 304 of a second device 10-2 to configure the devices 10-1, 10-2 together. In this way, a user of the combination of devices 10-1, 10-2 may grip both devices 10-1, 10-2 while applying downward pressure from the second device 10-2 onto the first device 10-1 to provide additional pressure at the interface between the first device 10-1 and the recipient of the massage.

In some embodiments as shown in FIG. 14, the combination of elements 302, 304, 306, 202-1, and 130 on a first tool 10-1 and on a second tool 10-2 enables the tools 10-1, 10-2 to be configured together in a variety of ways.

For example, in one embodiment as shown in FIG. 14A, the tip of the ridge 130-1 of a first tool 10-1 may be configured with (e.g., inserted into) the upper slot 302-2 of a second tool 10-2 to form a multi-device assembly 400.

In another example, in one embodiment as shown in FIG. 14B, the tip of the ridge 202-1 of a first tool 10-1 may be configured with (e.g., inserted into) the upper slot 302-2 of a second tool 10-2 to form a multi-device assembly 400. It is understood that other ridges 202-2 and 202-3 also may be inserted into upper slot 302-1 to form a multi-device assembly 400

In another example, in one embodiment as shown in FIG. 14C, the tip of the rear tab 304-1 of a first tool 10-1 may be configured with (e.g., inserted into) the rear slot 306-2 of a second tool 10-2 to form a multi-device assembly 400.

In another example, in one embodiment as shown in FIG. 14D, the tip of the bottom handle ridge 130-1 of a first tool 10-1 may be configured with (e.g., inserted into) the rear slot 306-2 of a second tool 10-2 to form a multi-device assembly 400.

In another example, in one embodiment as shown in FIG. 14E, the tip of the ridge 202-1 of a first tool 10-1 may be configured with (e.g., inserted into) the upper slot 302-2 of a second tool 10-2 to form a multi-device assembly 400. Note that in this embodiment, the first and second tools 10-1, 10-2 may be oriented in generally opposite directions. It is understood that other ridges 202-2 and 202-3 also may be inserted into upper slot 302-1 to form a multi-device assembly 400.

It is understood that the example configurations of a first tool 10-1 with a second tool 10-2 to form a multi-device tool 400 are meant for demonstration and that a multi-device tool 400 may be formed by configuring any ridge or tab (e.g., 202-1, 202-2, 202-3, 126, 128, 130, etc.) on a first tool 10-1 with any slot 302-2, 306-2, etc.) on a second tool 10-2.

In Use

Whether used in unison or individually, the ridges 202 are designed to provide cross-fiber friction to the massage recipient's muscles, thereby breaking scar tissue adhesions and lengthening peripheral nerves.

Nerve lengthening is a trade technique employed by expert acupressure technicians. The ability to manipulate peripheral nerves is achieved by targeted, significant downward pressure that makes strong contact with the nerve and subsequently pulls it away from the spinal cord with the temporary grip that the pressure secures. Most massage therapists lack the necessary strength and exactitude in targeting these nerves manually (using his/her hands) to lengthen the nerves correctly, which is the key to reversing spasms that are chronic in pain sufferers.

In one exemplary embodiment hereof, the curvature of the surface 201 from which the ridges 202 protrude, the alignment of the ridge's tips 206 with respect to one another and the tips' curvatures (e.g., opposing orca fin shapes) are designed to form fit individual muscles (or groups of muscles) of the massage recipient so that the ridges 202 may make contact with, grab/grip, secure and then rake the muscle fibers (using a back-and-forth rolling motion). This action may create cross-fiber friction that eradicates scar tissue adhesions while lengthening and/or elongating associated nerves In this way, the ridges 202 may act as cross fiber ridges 202. The scar tissue is broken between the muscles, tendons, ligaments and nerves and peripheral nerves are lengthened away from the spinal cord. This action may break down scar tissue adhesions between the muscles and pull and lengthen peripheral nerves away from the spinal cord.

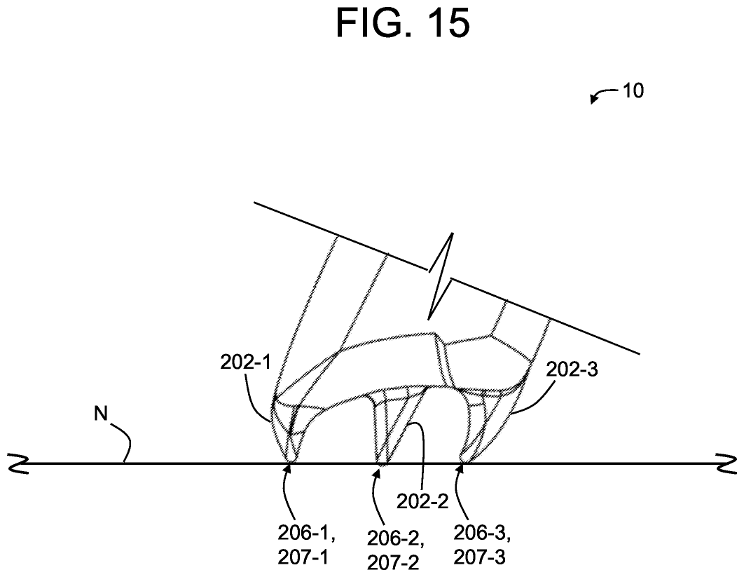

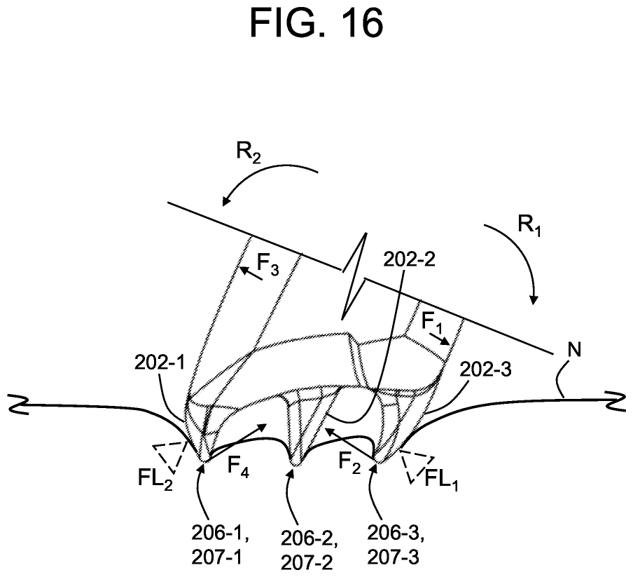

In one embodiment as shown in FIG. 15, one or more tips 206 (and blades 207) of one or more respective ridges 202 are placed in contact with the surface N of a massage recipient in preparation to perform a massage. As shown in FIG. 16, the tool 10 may then be pressed downward such that the one or more tips 206 (and blades 207) press against the recipient's skin causing deformations in the skin and applying pressure to the muscles beneath.

In this configuration, one or more of the ridges 202 may act as a lever as the tool 10 is sequentially rocked back and forth in the directions of the arrows R1 and R2. For example, a force F₁ applied to the tool 10 during a rocking motion in the direction of arrow R1 may set up a fulcrum FL₁ between the ridge 202-3 and the recipient's skin N creating a resultant lever force F₂ applied by the tip 206-3 (and blade 207-3) to the recipient's muscles beneath the surface of his/her skin N.

Similarly, a force F₃ applied to the tool 10 during a rocking motion in the direction of arrow R₂ may set up a fulcrum FL₂ between the ridge 202-1 and the recipient's skin N creating a resultant lever force F₄ applied by the tip 206-1 (and blade 207-1) to the recipient's muscles beneath the surface of his/her skin N.

Accordingly, each of these lever forces F₂ and F₄ applied to the recipient's underlying muscles provides a rolling curved penetration of the tips 206-3, 206-1 (and blades 207-3, 207-1), respectively, to the recipient's underlying muscles thereby providing the cross-fiber friction necessary to break down scar tissue adhesions and to lengthen the peripheral nerves in the area.

In one example, the first and second ridges 202-1, 202-2 may be used individually for specialized tasks. For instance, the first (and possibly smaller) ridge 202-1 may designed to penetrate between the bone and the muscle. In another example, the third (and possibly larger) ridge 202-3 may be designed to penetrate and compress larger, bulkier muscles such as the massage recipient's “erector spinae”.

In another example of use, ridge 202-1 is used to separate and wedge muscle from adjacent bone.

In another example of use, ridge 202-3 is used to perform deep tissue cuts into larger muscle groups as well as different maneuvers of nerve lengthening.

In another example of use, the side ridges 126, 128 and the rear tab 304, being used as a massage ridge 202, are used to perform a deep tissue cut into larger muscle groups with downward pressure of an individual device 10 (e.g., for use on the erector spine or the iliocostalis lumborum on a 90-degree cut).

In another example of use, the combined assembly 400 may be used to exert additional downward pressure with higher precision (e.g., because the combined assembly 400 is gripped with both hands). In this way, the combined assembly 400 may be used to perform deep tissue cuts on larger muscles as well as different nerve lengthening maneuvers. In one example of this type, the assembly 400 may be used to perform a 90-degree cut on the recipient's erector spine or the iliocostalis lumborum.

In some embodiments, the device 10 may be provided in different sizes for use by persons having different sized hands. For example, the device 10 may be provided in small, medium, large and extra-large sizes (or other sizes as appropriate). In some embodiments, each size of the device 10 may be proportional to the other sizes with respect to the dimensions of the device's elements. In other embodiments, some dimensions of some elements of the device 10 may not necessarily be proportional to one another for the different sizes. For example, the sizes of the ridges 202 may remain constant with each different size of the device 10.

In some embodiments, the device 10 is about 7.5″ to 8″ long from the front 108 to the back 110. In some embodiments, the width of the handle grip portion 102 is about 1.25″ to 1.5″ at its widest point. It is understood that these dimensions are presented for demonstration and that other dimensions may be used.

It is understood that any details of any elements and components of any of the embodiments disclosed herein may be combined to form additional embodiments of the device 10 that are included in the scope of the device 10.

Those of ordinary skill in the art will appreciate and understand, upon reading this description, that embodiments hereof may provide different and/or other advantages, and that not all embodiments or implementations need have all advantages.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1. A massage device comprising:
a handle including a surface;
a first projection including a first proximal end configured with the surface and a first distal end extending therefrom, the first projection including a first convex surface extending from the first proximal end to the first distal end, and a first concave surface opposite the first convex surface and extending from the first proximal end to the first distal end, the first convex surface and the first concave surface converging at a first projection tip; and
a second projection including a second proximal end configured with the surface and a second distal end extending therefrom, the second projection including a second convex surface extending from the second proximal end to the second distal end, and a second concave surface opposite the second convex surface and extending from the second proximal end to the second distal end, the second convex surface and the second concave surface converging at a second projection tip;
wherein the first concave surface and the second concave surface are opposing.

2. The massage device of claim 1 further comprising a third projection including a third proximal end configured with the surface and a third distal end extending therefrom, the third projection positioned between the first and second projections.

3. The massage device of claim 2 wherein the first, second, and third projections are arranged in a single row.

4. The massage device of claim 1 wherein the first and second projections are stationary.

5. The massage device of claim 1 wherein the first projection includes a first width between the first convex surface and the first concave surface at the first proximal end, a second width between the first convex surface and the first concave surface at a midpoint between the first proximal end and the first distal end, and a third width between the first convex surface and the first concave surface at the first distal end, and the second width is 70%-90% the first width, and the third width is 25%-75% the second width.

6. The massage device of claim 1 wherein the first projection includes a first width between the first convex surface and the first concave surface at the first proximal end, a second width between the first convex surface and the first concave surface at a midpoint between the first proximal end and the first distal end, and a third width between the first convex surface and the first concave surface at the first distal end, and the second width is 78%-82% the first width, and the third width is 48%-52% the second width.

7. The massage device of claim 5 wherein the first convex surface at the first proximal end and at the midpoint is adapted to engage a recipient's skin, and wherein the first convex surface at the midpoint sets up a fulcrum for a force applied to the first proximal end to be transferred to the first distal end.

8. The massage device of claim 1 wherein the first projection and the second projection mirror one another.

9. The massage device of claim 1 wherein a first convex surface length of the first convex surface between the first proximal end and the first distal end is greater than a first concave surface length of the first concave surface between the first proximal end and the first distal end.

10. The massage device of claim 1 wherein a first convex surface length of the first convex surface between the first proximal end and the first distal end is at least 10% greater than a first concave surface length of the first concave surface between the first proximal end and the first distal end.

11. A handheld massage device comprising:
a handle including a front and a back and a longitudinal axis passing between the front and the back, and a lower surface oriented at an angle of 30°-60° with respect to the longitudinal axis;
a first projection including a first proximal end configured with the lower surface and a first distal end extending therefrom, the first projection including a first convex surface extending from the first proximal end to the first distal end, and a first concave surface opposite the first convex surface and extending from the first proximal end to the first distal end, the first convex surface and the first concave surface converging at a first projection tip; and
a second projection including a second proximal end configured with the lower surface and a second distal end extending therefrom, the second projection including a second convex surface extending from the second proximal end to the second distal end, and a second concave surface opposite the second convex surface and extending from the second proximal end to the second distal end, the second convex surface and the second concave surface converging at a second projection tip;
wherein the first concave surface and the second concave surface are opposing.

12. The massage device of claim 11 further comprising a third projection including a third proximal end configured with the surface and a third distal end extending therefrom, the third projection positioned between the first and second projections.

13. The massage device of claim 12 wherein the first, second, and third projections are arranged in a single row.

14. The massage device of claim 11 wherein the first and second projections are stationary.

15. The massage device of claim 11 wherein the first projection includes a first width between the first convex surface and the first concave surface at the first proximal end, a second width between the first convex surface and the first concave surface at a midpoint between the first proximal end and the first distal end, and a third width between the first convex surface and the first concave surface at the first distal end, and the second width is 70%-90% the first width, and the third width is 25%-75% the second width.

16. The massage device of claim 11 wherein the first projection includes a first width between the first convex surface and the first concave surface at the first proximal end, a second width between the first convex surface and the first concave surface at a midpoint between the first proximal end and the first distal end, and a third width between the first convex surface and the first concave surface at the first distal end, and the second width is 78%-82% the first width, and the third width is 48%-52% the second width.

17. The massage device of claim 15 wherein the first convex surface at the first proximal end and at the midpoint is adapted to engage a recipient's skin, and wherein the first convex surface at the midpoint sets up a fulcrum for a force applied to the first proximal end to be transferred to the first distal end.

18. The massage device of claim 11 wherein the first projection and the second projection mirror one another.

19. The massage device of claim 11 wherein a first convex surface length of the first convex surface between the first proximal end and the first distal end is greater than a first concave surface length of the first concave surface between the first proximal end and the first distal end.

20. The massage device of claim 11 wherein a first convex surface length of the first convex surface between the first proximal end and the first distal end is at least 10% greater than a first concave surface length of the first concave surface between the first proximal end and the first distal end.
